(19) United States
(12) Patent Application Publication
(10) Pub. No.: US 2006/0141890 A1
(43) Pub. Date: Jun. 29, 2006

(54) Ultrasonic lamination

(76) Inventors: Eberhard Link, Raleigh, NC (US); Charles R. Mason, Nashua, NH (US); James Frasch, Hollis, NH (US); Amelia Tosti, Durham, NC (US); Ashutosh Karnik, Andover, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/261,454

(22) Filed: Oct. 28, 2005

Related U.S. Application Data
(60) Provisional application No. 60/622,896, filed on Oct. 28, 2004.

(51) Int. Cl. B32B 5/26; D04H 1/46; D04H 1/00

(52) U.S. Cl. 442/414; 442/402; 442/415; 442/381

(57) ABSTRACT

The present invention is directed at the field of ultrasonic welding of flame retardant materials. In one exemplary embodiment, two layers of non-woven fabrics may be welded together to create a woven appearance and which may resemble the appearance of a woven fabric, such as that used in mattress ticking.

### CROSS REFERENCE TO RELATED APPLICATIONS

The present application claims the benefit of the filing date of U.S. Provisional Application Ser. No. 60/622,896 filed Oct. 28, 2004, the teachings of which are incorporated herein by reference.

### FIELD OF INVENTION

The present invention pertains to the field of ultrasonic welding flame retardant materials. Particularly, the present invention pertains to the use of ultrasonic welding to bond two layers of non-woven fabrics together to create a woven appearance and mimic the appearance of woven fabrics. More particularly, the present invention pertains to ultrasonic lamination of a flame retardant material to a secondary layer to support the flame retardant material or to a fillercloth.

### BACKGROUND

There are a number of methods available to form fibers into fabrics for applications such as upholstery, mattress ticking, panel fabric, etc. Single or blended fibers may be blended into a single layered sheet structures through processes including, but not limited to, air-laying, carding, needlepunching or spunbonding. Other times, multiple layers of single or blended fibers may be joined together to create a sheet structure through process including but not limited to needlepunching or ultrasonic welding.

Ultrasonic welding is a well known method in the materials industry used to weld sheets of material together. U.S. Pat. No. 3,733,238 is one of many examples of ultrasonic welding thermoplastic sheet-like elements. A general object of that invention was to produce “full width” thermoplastic laminated material without any patterning restriction. Other examples ultrasonic bonding include, but are not limited to the following. U.S. Pat. No. 4,686,136 discloses a method of forming a laminated fabric using ultrasonic energy. Inner air-laid, batt-like material is used to produce a laminate in which columns extend through the batt to unite the outer shell fabrics with each other and the batt. U.S. Pat. No. 6,468,931 discloses a multilayer thermally bonded nonwoven fabric that includes at least two prebonded nonwoven webs, having intralaminar bonds within the webs and interlaminar bonds between the two webs. Also discussed is the use of pinsonic bonding for ultrasonically bonding the fabrics together and forming visual patterns or designs. U.S. Pat. No. 6,471,804 discloses the use of two ultrasonic welding stations to fix pieces of material on a continuously advancing web. The first station attaches the material over a limited attachment area; the second station fixes the pieces onto the web.

It has also been reported that flame resistant fibers may be ultrasonically welded together. For example, U.S. Pat. No. 5,962,112 generally discloses the use of fire retardants blended with thermoplastic material for increased resistance to fire. U.S. Pat. No. 4,888,091 discloses the combination of fire resistant aramid fibers with fusible aramid fibers in sheet structures and fusing the sheet structure using ultrasonic vibration. U.S. Pat. No. 4,686,136, discussed above, further reports the use of Nomex aramid fibers in fabrics fused by ultrasonic bonding.

Furthermore, there are a number of disclosures directed to the burning characteristics of fiber materials. Examples of such disclosures include, but are not limited to the following. U.S. Pat. No. 4,600,606 describes a method of flame retarding textile and related fibrous materials, which relies upon the use of a water-insoluble, non-phosphorous containing brominated aromatic or cycloaliphatic compounds along with a metal oxide. U.S. Pat. No. 4,026,808 reports on the use of a phosphorous containing N-hydroxy-methyl amide and tetrakis(hydroxymethyl) phosphonium chloride. U.S. Pat. No. 3,955,032 discusses the use of chlorinated-cyclopentadieno compounds and chlorobrominated-cyclpentadieno compounds, either alone or in combination with metal oxides.

U.S. Pat. No. 4,702,861 describes a flame retardant composition for application as an aqueous working dispersion onto surfaces of combustible materials. Upon exposure to elevated temperatures and/or flame, the formulation reportedly creates a substantially continuous protective film generally encapsulating and/or enveloping the surface of the article onto which it is applied. The film-forming materials are based upon an aqueous latex dispersion of polyvinylchloride-acrylic copolymer together with certain other film-forming and viscosity controlling components.

Other disclosures which offer additional background information include U.S. Pat. No. 4,776,854 entitled “Method for Flameproofing Cellulosic Fibrous Materials”; U.S. Pat. No. 5,051,111 entitled “Fibrous Material”; 5,569,528 entitled “Treating Agent for Cellulosic Textile Material and Process for Treating Cellulosic Textile Material”; and U.S. Pat. No. 6,309,565 entitled “Formaldehyde-Free Flame Retardant Treatment for Cellulose-Containing Materials”.

It is also worth mentioning that within the various efforts to provide flame resistant fabric products, various polymers themselves have emerged as substrates for use as flame resistant fibers. For example, melamine and melamine/formaldehyde based resinous fibers are said to display desirable heat stability, solvent resistance, low flammability and high-wear characteristics. One form of melamine/formaldehyde fiber is marketed under the tradename Basofil™. In addition, the aromatic polyamide family or aramids reportedly have high strength, toughness, and thermal stability. Aramid fibers are marketed under the tradenames Nomex™ and Kevlar™.

Furthermore, acrylic fibers are well-known in the synthetic fiber and fabric industries, as are the modified acrylic fibers (modacrylic). Such modacrylics are relatively inexpensive, and have been used in various blends with the fibers noted above to provide fire-resistant fabric material. One particular modacrylic fiber is sold under the tradename Kanecaron™ Protex, which is available from Kaneka Corporation, Japan.

In addition, flame retardant viscose fibers have become available, and one particular viscose fiber is sold under the tradename Visil™. More specifically, Visil™ is said to comprise a silicic acid containing viscose, with a limiting oxygen index (i.e., the minimum concentration of oxygen necessary to support combustion) in the range of 27-35, depending upon a particular textile construction.

Finally, it is worth noting that various manufacturers have produced and sold fire-resistant fabric material. They are as follows: 1. E. R. Carpenter's “Fire Stop™”, which relies upon Basofil™/modacrylic high loft batting; 2. Chiquola Industrial Fabric's “FireGuard™” which relies upon core spun flame retardant yarns into woven or knit form; 3. ChemTick Coated Fabrics “Flame Safe™” which relies upon core spun yarn in woven configuration with flame retardant treatment; 4. Elk Corporation's “VersaShield™” which relies upon a woven fiberglass base with a soft foam like coating on one side; 5. Jones Fiber Products, Inc.'s “T-Bond™” which relates to a flame retardant treatment of cotton batting; 6. Legett & Platt's “Pyro-Gon™” which is a batting of a blend of Pyron (panox) fibers with other fibers; 7. MLM, LLC's “Allesandra” which is a core spun flame retardant yarn in woven form; 8. Tex Tech's various blends of Basofil™ and Nomex™, Kevlar™ and PBI in the form of needlepunched felts; and 9. Ventex's “Integrity 30™”, SpunGold™ and AKTIV™ which collectively relate to various products of knits and nonwoven battings that may include Basofil™, Panox, Kevlar™ or Nomex™.

It is therefore an object of the present invention to expand upon the technology directed at the manufacture of flame retardant materials, and develop a fire resistant ultrasonically bonded material that can serve, among other things, as a protective liner material for fillercloth and mimic the appearance of woven materials such as those used in mattress ticking.

It is also an object of the present invention to provide a fire-resistant material which relies upon an ultrasonically bonded non-woven manufacture of two principal components, wherein one component is selected to provide non-burning characteristics, and a second component is selected to support and maintain the first component while creating the appearance of a woven fabric and more specifically mattress ticking.

### SUMMARY

According to one aspect the present invention includes, a fire blocking non-woven textile structure comprises a first layer and a second layer ultrasonically bonded to the first layer, the first layer having a needle-punched textile structure, comprising a first fiber component containing polyacrylonitrile copolymer with a halogen containing monomer; a second fiber component selected from the group consisting of a viscose fiber containing silicic acid, a regenerated cellulose fiber, a melamine/formaldehyde fiber and mixtures thereof; and a third fiber component selected from the group consisting of an aramid fiber, a melamine/formaldehyde fiber, a polyester fiber and mixtures thereof; and the second layer comprising a thermoplastic fiber.

In another aspect, the present invention includes a fire blocking non-woven textile structure comprising a first composite layer and a second layer ultrasonically bonded to the first layer, the first composite layer comprising a needle-punched web including an aramid fiber, wherein the needle punched web including an aramid fiber is attached to a spunbond, melt blown or spunbond/meltblown composite web material and the second layer comprises a thermoplastic fiber.

In another aspect, the present invention includes a fire blocking non-woven textile structure comprising a first carded web including an aramid and/or melamine/formaldehyde fiber; a second carded web comprising a blend of polyacrylonitrile copolymer with a halogen comonomer and a polyester polymer, wherein the first carded web including aramid and/or melamine/formaldehyde fiber is needle punched with the second carded web of said blend to form a first layer; and a second layer comprising a thermoplastic fiber, wherein the needle punched first and second carded webs are ultrasonically bonded to the second layer.

In another aspect, the present invention includes a fire blocking non-woven textile structure comprising a first carded web including an aramid fiber and/or a melamine/formaldehyde fiber and a second carded web comprising a blend of binder fiber and a polyester polymer, wherein the first carded web contacts the second carded web of the blend to form a first layer; and a second layer comprising a thermoplastic fiber, the second layer ultrasonically bonded to the first layer.

### DETAILED DESCRIPTION OF THE PREFERRED EMBODIMENTS

The present invention pertains to the use of ultrasonic welding to bond two layers of non-woven fabrics together to create a woven appearance and mimic the appearance of quilted or woven fabrics. More specifically, the ultrasonic welding is spaced such that a visual pattern is formed that is similar to the appearance of traditional mattress border design. More particularly, the present invention pertains to ultrasonic lamination of a flame retardant material to a fillercloth or a secondary layer to support the flame retardant material. Accordingly, in the context of the present invention, the ultrasonic welding provides the appearance that the layers are stitched or sewn together at selected intervals. The intervals, of course, can be varied.

Turning to the various fiber components, the textile structure is preferably manufactured from a combination of modacrylic fiber with a second fiber component which may comprise a viscose fiber containing silicic acid, a regenerated cellulose fiber and/or a melamine formaldehyde polymer, as well as mixtures thereof, and a third fiber component which may comprise an aramid fiber, a melamine/formaldehyde fiber or a polyester fiber and mixtures thereof.

It should be noted that at least one factor contributing to the performance of this embodiment, as a unique fire resistant non-woven material, is the modacrylic fiber. When the modacrylic fiber is activated by heat, it apparently assists in the displacement of oxygen thereby reducing heat release and burn rate. However, the invention herein is not limited to any particular theorized functionality of the individual components and relies upon the various combinations that are ultimately described in the appended claims.

The modacrylic fiber is preferably based upon a polyacrylonitrile copolymer with a halogen containing comonomer, and the halogen containing comonomer is preferably poly(vinyl chloride) or poly(vinylidine chloride). A preferred modacrylic fiber is available from Kaneka Corporation, under the tradename Kanecaron™ Protex. In a most preferred embodiment, the modacrylic employed herein is sold under the tradename Kanecaron™ Protex PBX, at a specific gravity of 1.45-1.60 with a fiber denier of 2.2 dtex×38 mm. Protex PBX is described as having the following chemical components: acrylonitrile, vinylidine chloride copolymer, antimony oxide.

The viscose fiber is a general reference to a fiber produced by the viscose process in which cellulose is chemically converted into a compound for ultimate formation into a fiber material. A preferred viscose fiber containing silicic acid is sold under the tradename Visil™, available from Sateri Oy, Inc. The Visil™ fiber is type AP 33, 3.5 dtex×50 mm. It is composed of 65-75% regenerated cellulose, 25-35% silicic acid and 2-5% aluminum hydroxide. A preferred melamine/formaldehyde fiber component is sold under the tradename Basofil™, available from McKinnon-Land-Moran, LLC.

The regenerated cellulose fiber is generally a reference to cellulose that is first converted into a form suitable for fiber preparation (e.g. xanthation) and regenerated into the cellulose fiber form. A preferred regenerated cellulose fiber is prepared from wood pulp, e.g. lyocell fiber.

Expanding on the above, it is worth noting that the preferred use of the lycoell fiber herein is broadly defined herein as one example of a synthetic fiber produced from cellulosic substances. Lyocell is reportedly obtained by placing raw cellulose in an amine oxide solvent, the solution is filtered, extruded into an aqueous bath of dilute amine oxide, and coagulated into fiber form. From a property perspective, lyocell is also described as being a relatively soft, strong and absorbent fiber, with excellent wet strength, that happens to be wrinkle resistant, dyable to a number of colors, simulate silk or suede and maintains good drapabiltiy.

Preferably, the aramid fiber is reference to an aromatic polyamide type fiber material, such as a poly(p-phenylene terephthalamide) made by E.I. DuPont de Nemours & Co., sold under the tradename Kevlar®. Preferably, the aramid fiber is present at a level of less than or equal to 60.0% wt., including all percentages and ranges therein.

In addition, preferably, the denier of the fibers may be configured in the range of about 1-15 denier, including all increments and ranges therebetween. Preferably, the non-woven material will also have a basis weight of 100-500 g/m², including all increments therebetween at 1 g/m² variation. More preferably, the basis weight of any such fire blocking textile structure disclosed may be in the range of about 100-350 g/m².

The above referenced fire blocking non-woven textile therefore may preferably contain the modacrylic polymer component (e.g., polyacrylonitrile copolymer with poly(vinylidine chloride)) at levels of about 30-80% (wt.), the second fiber component which supports the modacrylic component may be present at about 10-50% (wt.) and the third fiber component is present at a level of about 10 30% (wt.). In a particularly preferred embodiment, the modacrylic component is present at about 70% (wt.) and the second fiber component is preferably a viscose fiber containing silicic acid and/or a melamine/formaldehyde polymer which is present at about 20% (wt.). In context of all of these preferred ranges, it should be understood that within the broad scope of this invention, all increments therebetween are included at 1% (wt.) variation.

In another preferred embodiment of the invention, polymer binder fiber is added to the non-woven textile. Such binder fiber has the capability to melt bond with the various fiber components. The preferred binder fiber is 4d×2″ from either Nan Ya or Sam Yang in Korea with the outer layer having a melting point of 150° C., which melting point is lower than the melting point of the inner layer of this particular binder fiber material. The binder fiber outer layer melts and flows onto the other fibers bonding the structure together. Preferably, the binder fiber is added to any of the fiber component combinations herein described.

Elaborating upon the above, and in the broad context of the present invention, the binder fibers of the present invention may include one or a plurality of polymer components. In addition, the binder fiber may be in the form of a sheath/core, side by side, or monofilament configuration.

An embodiment of the present invention may generally be described as having a first layer containing a flame retardant component and a second layer supporting said flame retarding component which may be composed of a fillercloth or another thermoplastic containing material that may be used to reinforce said first layer.

In an preferred embodiment, the first layer of the present invention includes a fire blocking non-woven textile structure having a needle-punched textile structure, comprising a first fiber component containing polyacrylonitrile copolymer with a halogen containing monomer; a second fiber component selected from the group consisting of a viscose fiber containing silicic acid, a regenerated cellulose fiber, a melamine/formaldehyde fiber and mixtures thereof; and a third fiber component selected from the group consisting of an aramid fiber, a melamine/formaldehyde fiber, a polyester fiber and mixtures thereof.

In another preferred embodiment, the first layer of the present invention includes a fire blocking non-woven textile structure comprising a needle-punched web including an aramid fiber, wherein the needle punched web including an aramid fiber is attached to a spunbond, melt blown or spunbond/meltblown composite web material and the second layer comprises a thermoplastic fiber.

In another preferred embodiment, the first layer of the present invention includes a fire blocking non-woven textile structure comprising a first carded web including an aramid and/or melamine/formaldehyde fiber; a second carded web comprising a blend of polyacrylonitrile copolymer with a halogen comonomer and a polyester polymer, wherein the first carded web including aramid and/or melamine/formaldehyde fiber is needle punched with the second carded web of said blend.

Another embodiment of the present invention includes a fire blocking non-woven textile structure comprising a first carded web including an aramid fiber and/or a melamine/formaldehyde fiber and a second carded web comprising a blend of binder fiber and a polyester polymer, wherein the first carded web contacts the second carded web of the blend.

In one embodiment, the second layer includes a fillercloth containing thermoplastic fibers to facilitate the ultrasonic lamination process. The fillercloth may be incorporated onto a mattress or used on the foundation or box spring. Preferably, the filler cloth contains spunbonded polypropylene fibers. More preferably, the fillercloth is composed of a stichbonded polypropylene spunbonded impregnated (acrylonitrile containing binder) having a weight of about 100 g/m², or a polypropylene spunbond having a weight of about 80 g/m², or a polypropylene spunweb needle punched and point seal calandered.

In another embodiment, the second layer is any material that can be used to reinforce the first flame retarding layer, as long as it includes thermoplastic fibers facilitating the ultrasonic lamination process. Preferably a thin, strong (less than 5 mm thickness and more than 100 Newtons/50 mm tensile strength) material may be used as a second layer. It should be appreciated that the laminated first and second layer may be used as a border material.

In an embodiment of the present invention the first and second layers are ultrasonically bonded or laminated together. Preferably, the ultrasonic lamination process may be used to develop visual patterns or designs along the surface of the textile structures. Most preferably, the ultrasonic bonding process imparts a woven appearance similar to that of mattress ticking via use of a single horn station, side-by-side over the width, on top of a design roller. The individual layers are simultaneously fed into the station and welded together while feeding through the gap between the horns and the design roller as a continuously advanced web.

In connection with the manufacture of the non-woven materials herein, containing aramid fiber in the first layer, it can be noted that given the inherent yellow color of the aramid fiber, it has been found that certain level of the aramid, in the non-woven, will cause the non-woven to similarly yellow, thereby providing an undesirable cosmetic effect for a mattress product. Accordingly, it has been found that such undesirable cosmetic feature can be addressed in the fire-blocking non-woven structure, containing an aramid fiber, wherein the needle punched web including the aramid fiber is needle punched or otherwise attached to a spunbond, a melt blown web or spunbond/meltblown composite material.

Those of skill in the art will recognize that a spunbond web material is a general reference to spunlaid technology in which the filaments have been extruded, drawn and laid on a moving belt to form a web. Accordingly, a polymer suitable for the formation of spunbond material may be introduced into an extruder, output to a spinning die, and collected on a web laydown belt and calendar bonded to form a web. In related fashion, a melt blown web material is a general reference to a non-woven web forming process that extrudes and draws molten polymer resin with heated, relatively high velocity air to form fine filaments. The filaments are cooled and collected as a web onto a moving belt. While similar to the spunbond process, the melt blown fibers tend to be finer and more generally measured in microns. Accordingly, melt blowing is another form of a spunlaid process.

Accordingly, the spunbond or meltblown materials suitable for needle punching or otherwise attaching to the aramid based non-wovens of the present invention preferably comprise a polyolefin or polyester based material. More preferably, the polyolefin is polypropylene. The objective then is to select that amount of spunbond or meltblown material for combining with the aramid based non-woven web to attenuate the yellow color that is typical for the aramid base web. Accordingly, by attaching a spunbond or meltblown to the aramid based non-woven web, the yellow color of the aramid based web is whitened to provide a more cosmetically pleasing resultant product.

In a related embodiment to the above, it has also been found that one can prepare a cosmetically pleasing fire-blocking product by first supplying a carded web of an aramid based fiber, e.g., a carded web of aramid with a viscose fiber containing silicic acid (e.g., Visil™). Preferably, the amount of aramid fiber is at a level of equal to or greater than 10% (wt.), and preferably, in the range of 10-60% (wt.), including all levels and ranges therebetween. The corresponding amount of viscose fiber is preferably present at a level between 40-90% (wt.), and at all levels and ranges therebetween.

Accordingly, other optional combinations of the first carded web include 5-25% (wt.) aramid fiber in combination with 95-75% (wt.) of a viscose fiber containing silicic acid. Furthermore, the first carded web may include 5-25% (wt.) melamine/formaldehyde fiber in combination with 95-75% (wt.) of a viscose containing silicic acid.

The above is followed by supplying a second carded web comprising a polyacrylonitrile based composition, which composition may preferably include a blend of polyacrylonitrile copolymer containing a halogen comonomer with a polyester polymer such as PET. Preferably, in the case of such blend, the polyacrylonitrile copolymer containing a halogen comonomer is present at a level of 70-30% (wt.) and the polyester is present at a level of 30-70% (wt.). Furthermore, the second carded web may include a blend of binder fiber and polyester polymer. Preferably, the second carded web also includes natural fibers and/or a polyacrylonitrile copolymer with a halogen comonomer. More preferably, the natural fibers are composed of wool and/or cotton.

The two carded webs may then be needle-punched under conditions wherein the needle-punching is controlled to the point wherein the yellow color of the aramid based carded web is whitened by the incorporation of the polyacrylonitrile web. One may further needle punch with a spunbond or meltblown web of polyolefin or polyester material. Additionally, the needle punched carded webs are then ultrasonically bonded to a second layer of a thermoplastic containing fiber.

While the invention has been described in detail with reference to specific preferred embodiments, it will be appreciated that various changes and modifications can be made, and equivalents employed, without departing from the scope of the following claims.

1. A fire blocking non-woven textile structure, comprising
a first layer and a second layer ultrasonically bonded to said first layer, said first layer having a needle-punched textile structure, comprising a first fiber component containing polyacrylonitrile copolymer with a halogen containing monomer; a second fiber component selected from the group consisting of a viscose fiber containing silicic acid, a regenerated cellulose fiber, a melamine/formaldehyde fiber and mixtures thereof; and a third fiber component selected from the group consisting of an aramid fiber, a melamine/formaldehyde fiber, a polyester fiber and mixtures thereof; and said second layer comprising a thermoplastic fiber.

2. The fire blocking non-woven textile structure of claim 1 wherein said second layer is a fillercloth.

3. The fire blocking non-woven textile structure of claim 2 wherein said fillercloth further comprises a spunbond, stichbonded, impregnated polypropylene.

4. The fire blocking non-woven textile structure of claim 2 wherein said fillercloth further comprises a spunbond polypropylene.

5. The fire blocking non-woven textile structure of claim 2 wherein said filler cloth further comprises a polypropylene spunweb needle punched material and is point seal calandered.

6. The fire blocking non-woven textile structure of claim 1 wherein said second layer supports said first layer, whereby said second layer reinforces said first layer.

7. The fire blocking non-woven textile structure of claim 1, wherein said third fiber component comprises an aramid fiber and said aramid fiber is present at a level of less than or equal to about 60.0% (wt.).

8. The fire blocking non-woven textile structure of claim 1 wherein said first fiber component is present at a level of about 30-80% (wt.), said second fiber component is present at a level of about 10-50% (wt.), and said third fiber component is present at a level of about 10-30% (wt.).

9. The fire blocking non-woven textile structure of claim 1 wherein said aramid fiber is poly(p-phenylene terephthalamide).

10. The fire blocking non-woven textile structure of claim 1 wherein said polyester fiber is poly(ethylene terephthalate).

11. The fire blocking non-woven textile structure of claim 1 wherein said first layer comprises 1.0-15.0 denier fibers.

12. The fire blocking non-woven textile structure of claim 1 wherein said first layer has a basis weight of about 100-350 g/m².

13. The fire blocking non-woven textile structure of claim 1 wherein said regenerated cellulose fiber is a lyocell fiber.

14. The fire blocking non-woven textile structure of claim 1, further including a binder fiber.

15. The fire blocking non-woven textile structure of claim 14, wherein said binder fiber comprises a sheath/core, side-by-side or monofilament construction.

16.-56. (canceled)
